(19) United States
(12) Patent Application Publication
(10) Pub. No.: US 2003/0091702 A1
(43) Pub. Date: May 15, 2003

(54) Disposable piping bags and nozzles therefor

(76) Inventor: Jan Folkmar, Arosa (CH)

Correspondence Address: KENNETH M. GARRETT, 392 LAKESHORE ROAD EAST, OAKVILLE, ON, L6J 1J8, CA

(21) Appl. No.: 09/987,042

(22) Filed: Nov. 13, 2001

(51) Int. Cl. A23B 4/00

(52) U.S. Cl. 426/115

(57) ABSTRACT

Piping bags including a nozzle base portion that is inserted into a pouch through the fill opening and pulled into wedged, sealed position within the pouch. The nozzle base portion is provided with surface dislocations which resist the dislodgement of the nozzle base under the influence of various forces to which it is or may be subjected. The nozzle also includes a cap portion which is selectively matable with the base portion, and which serves inter alia to trap portions of the pouch to resist the dislodgement of the nozzle. The pouch itself may suitably form a security seal where the bag is distributed in a filled condition.

### FIELD OF INVENTION

This invention relates to devices commonly referred to as piping bags, pastry bags or icing bags. Such bags are generally filled with a thick, flowable material such as icing, pureed fruit or vegetable, or mayonnaise, which is expressed from the bag through a nozzle, usually to achieve a decorative effect. The invention more particularly relates to disposable piping bags and nozzles therefor.

### BACKGROUND OF INVENTION

Refillable piping bags of the prior art typically include a pouch having an open upper end defining a fill opening, and an open lower end of smaller transverse cross sectional dimension than that of the upper end, defining an outlet end. Typically, the pouch wall is constructed from a durable, impervious fabric that is permanently bonded to a nozzle base at the outlet end, to which base must be selectively connected a nozzle tip of desired cross-sectional shape to provide a pre-determined decorative effect. Improvements relating to such bags are described in the following patent documents:

| | | |
|---|---|---|
| U.S. Pat. | 5,931,346 | Wallays |
| | 5,026,194 | Lewis |
| | 4,961,517 | Tkac |
| | 4,844,917 | DeLorimiere |
| | 4,776,488 | Gurzan |
| | 4,205,765 | May |
| U.S. Application | 6,179,165B1 | Knight et al |

It is well established that fabric piping bags are usually contaminated with pathogens even after cleansing in a manner to which they would be commonly subject in a domestic or small scale commercial facility. It is known to provide disposable piping bags in the form of kits. As will be subsequently described in greater detail, one such kit includes a pouch constructed form plastic film having a flat, triangular shape when empty, and which is accordingly similar to that of the reusable fabric bags mentioned above. These disposable bags require a nozzle, which is provided as part of the kit, to be inserted through the fill opening of the bag, and wedged tightly into the pouch adjacent to the dispensing opening. While disposable bags formed from this kit are generally suited for small-scale domestic use, they are inappropriate for large-scale commercial use or for distribution in a filled condition. Moreover, they do not permit the nozzle shape to be changed once the pouch is filled, nor do they facilitate the storage of the bags when filled or following their partial use.

A difficulty associated with this kit is that of retaining the nozzle in its wedged, sealed position within the pouch, due to a reactive force exerted by the pouch upon the conically inclined surface of the nozzle. In practice, a further dislodging force may often arise due to inadvertence; typically, when filling the bag, the nozzle may contact a support surface such as a kitchen counter-top, whereby the nozzle is pushed towards the interior of the bag. These problems are likely to be even more acute where the bags are intended for commercial or professional use, as they will generally be larger and heavier. Moreover, while the pouches are intended to be disposable following their use, it may be preferred that the nozzles be re-used, in which case stainless steel may be a preferred material of construction. The coefficient of friction between this material and most plastic materials of likely interest for forming a disposable pouch is relatively low, and it has not been practical heretofore to provide disposable piping bags with stainless steel nozzles.

It is also known to distribute pre-mixed cake icing which is hermetically sealed within a collapsible plastic tube having an outlet unitarily formed therewith. Such tubes are relatively small, and are intended for a single use. The tubes have a nipple-like outlet end, and the user makes the outlet opening by cutting off the end of the nipple with scissors or the like. There is no provision for coupling these bags to nozzle caps of different cross sections or for closing the tubes once they have been opened.

In order to be economically viable, disposable piping bags should be inexpensive to produce and distribute, and they should not significantly increase the cost of production of the various types of substances that may be sealed and distributed in the bags.

It is an object of this invention to provide disposable piping bags to which nozzle caps of different types may be coupled without necessitating the bag being empty.

It is a further object of this invention to provide disposable piping bags that may be filled and distributed in a sealed condition, to which nozzle caps of different cross-section may be coupled.

It is another object of this invention to provide economic kits to facilitate the easy and convenient assembly of disposable, sealable piping bags.

It is yet another object of this invention to provide nozzles, including stainless steel nozzles, for piping bags that are easily assembled with disposable pouches, to form piping bags to which nozzle tips of various types may be selectively coupled when the bag is filled, so as to close the bag for storage or through which the contents of the bag may be extruded for different decorative effects.

### SUMMARY OF THE INVENTION

In accordance with one aspect of this invention, a disposable piping bag comprises a pouch with an expressible, viscous medium sealed therein. The pouch is constructed from a thin, flexible material, with plastic film being particularly suited and preferred, so as to collapse on the expression of the medium from the pouch. The pouch has a neck portion adjacent one axial end thereof having conically reducing transverse cross-sections. The piping bag further comprises nozzle means including a funnel-like base that comprises conically inclined wall portions connected in flow relationship with a spout portion. The nozzle base is disposed at least in part within the pouch with neck portions thereof in gripping, relationship with the conically inclined wall portions of the nozzle base so as to create a seal therewith. The nozzle means further comprises a nozzle cap disposed outside of the pouch; the nozzle base and the nozzle cap include complementary coupling means for selectively coupling the nozzle cap to said nozzle base, with portions of the pouch trapped therebetween; and, security seal means close the outlet of the spout portion to prevent the expression of the medium from the pouch.

Suitably and preferably, the conically inclined portions of the nozzle base are generally smooth walled on their outwardly facing surface, so as to provide a good area of sealing contact between the nozzle base and the pouch. Over a period of time, it is found that the sealing contact between the pouch and the nozzle base is reduced, due at least in part to reactive forces generated by the pouch that tend to urge the base from its sealing contact with the walls of the pouch. This problem may be particularly acute when the medium contained within the pouch has a high fat or oil content, such as mayonnaise or whipped butter, for example. Accordingly, the conically inclined wall portions of the nozzle base portion are suitably and preferably provided with surface dislocations thereon which function to counteract these reactive forces. Preferably, the dislocations are raised on the conical walls of the nozzle base, although they may also comprise or include surface indentations, particularly where the pouch is shrunk into the nozzle base, or where one or more constrictive elements are used to clamp the pouch wall to the nozzle base. Suitably, the dislocations extend arcuately across the surface of the conical walls. In accordance with the preferred, illustrative embodiment, the surface dislocations comprise several annular bands raised on the surface of the base portion, but it will be understood that the number and type of dislocations may vary widely and that they may be selected in accordance with different factors such as the conical angle of the base portion of the nozzles, and the materials of construction of the nozzle and the pouch. It will also be understood that the nozzle cap, where it serves to trap portions of the pouch, will also act in addition to the surface deformations to resist the reactive, dislodging force generated on the nozzle base by the pouch walls.

Suitably and preferably, the piping bag may comprise a selection of the nozzle caps, and include, for example a cap which may be used to close the outlet opening of the nozzle base when the bag is stored for a period of time, and one or more elongated caps with a bore therethrough to thereby form nozzle tips of different cross-sections to provide different artistic effects when extruding piping material from the bag.

The outlet end of the pouch may suitably terminate in a nipple, which will preferably be sealed and which must be severed by a user prior to extruding material from the bag. This feature is of advantage to the domestic user, as it permits the pouch to be filled by the user without material dripping out through the outlet opening. It is also of advantage to the commercial user who intends to distribute the piping bags complete with a filling medium, as it permits the filled bags to be hermetically sealed and sterilized, thereby increasing the shelf-life of the product. Moreover, the piping bags sealed in this manner do not require the addition of any anti-tamper security means at the outlet end thereof, thereby avoiding the concomitant costs associated therewith. Suitably, in this case, the nozzle cap will serve to physically protect the nipple until such time as it is desired to use the piping bag, in addition to its other function or functions once the bag is unsealed for use.

The preferred means for coupling the nozzle cap to the nozzle base comprises thread means, suitably with male threads disposed on the spout portion of the nozzle base and female threads disposed on the cap, although other coupling means including snap couplings, for example, may be employed.

Given that the piping bags are intended to be disposable, it is necessary that they be of relatively low cost. One of the preferred features of a piping bag intended to be filled by the user is a resealable closure for the filling end of the bag, preferably of the push together zip type. Where the pouch has a triangular shape when flat, the length of the fill opening for a given bag volume tends to be rather high, and given the relatively high cost of zip-type resealable closures, this would be a burdensome factor. A still further cost factor associated with resealable triangular pouches is in the material wastage in manufacture. Generally speaking, a film pouch will be manufactured from two overlaying bands of film that are fused together to define the margins of the pouch. Where a resealable zip type closure is required, this will normally be molded along one lateral margin of the sheets only. Accordingly, approximately one half of the sheet material will be wasted when the pouches are formed in this manner. Yet another disadvantage associated with, the triangular pouches is in the difficulty in assessing the amount of material within the pouch, as this will vary in a non-linear manner with the height of the material in the pouch. In accordance with one aspect of this invention, pouches for use with piping bag assemblies have art elongated, pentagonal fore. Pouches of this form offer improvements over the triangular from pouches in each of the above areas, and are also advantageous for the user in facilitating the expression of medium from the bag, particularly where the bags are relatively large. This type of bag has a still her advantage in that it is readily manufactured and distributed in a web, to facilitate its handling by an industrial user in automated fill equipment.

The invention also contemplates piping bag kits comprising nozzle means and pouches as described above in connection with the first aspect of the invention.

Having described the broad aspects of the invention, it will be further described in relation to presently preferred embodiments thereof, from which still further objects, aims and advantages of the invention will become apparent.

### BRIEF DESCRIPTION OF THE DRAWINGS

FIG. 1 shows in elevation an exploded fragmentary view of a prior art disposable piping bag arrangement;

FIG. 2 shows in elevation a filled piping bag in accordance with the invention, broken to indicate indefinite length and cut away to reveal detail;

FIG. 3 shows in longitudinal cross-section the first part of a nozzle means as used in the arrangement of FIG. 2;

FIG. 4 shows in longitudinal cross-section a second part of a nozzle means which may be coupled to the first part as an alternative to the second part shown in FIG. 2;

FIG. 5 shows in elevation a film pouch of a type used in the assembly of FIG. 2;

FIG. 6 shows a film web in which pouches such as that seen in FIG. 5 are formed;

FIG. 7 shows a cross-section on line 7-7 of FIG. 6; and

FIG. 8 is similar to FIG. 3, but shows the addition of a security seal thereto.

### DESCRIPTION OF THE PREFERRED EMBODIMENT

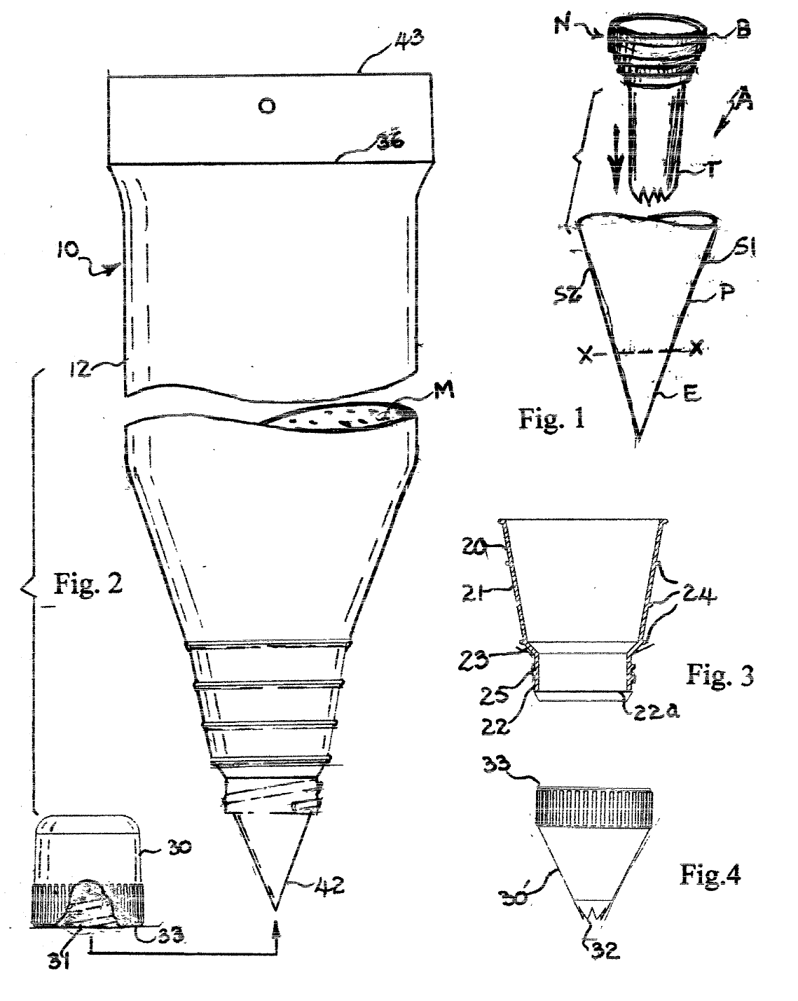

Referring to the drawings in detail, a prior art piping bag assembly as seen in FIG. 1 is identified generally therein by the letter A. Assembly A includes a plastic film pouch P which comprises a pair of overlying film sheets F1, P2 Joined together along convergent sides S1 S2 to folds a nipple at end E. Only the lower portion of pouch P is illustrated, but it is to be understood that sides S1, S2 are continuously divergent from end E to the upper edge of pouch P, the pouch having a triangular form as is common with fabric pasty bags of the prior art. Assembly A further comprises a nozzle N including a stepped, frusto-conical base portion B and unitarily formed therewith, a tip portion T. Prior to the assembly of pouch P and nozzle N, a user is instructed to sever end E along line X-X so as to provide an opening through which the tip portion T of nozzle N will project when the nozzle is passed through the pouch from the upper end. Tip portion T is then pulled from below the pouch, so as to engage base portion B in wedged, sealed relationship with the walls of the pouch. Over a period of time, the reactive force generated by pouch P on nozzle base B will tend to urge the nozzle base out of its sealing relationship with the pouch, and leakage of medium contained within the pouch will occur. This problem is particularly acute when the medium has significant oil or fat component, such as mayonnaise or whipped butter.

FIGS. 2 and 3 illustrate the improved piping bag assembly of the invention, which is identified therein generally by the numeral 10. Assembly 10 comprises a pouch 12, and a nozzle means comprising a first part 20, best seen in FIG. 3. First part 20 is broadly funnel shaped and includes a base portion 21 which is upwardly outwardly divergent in a frusto-conical form, and which connects in flow relationship with a right circular tubular spout 22 with an outlet 22a, and a transitional downwardly, inwardly, inclined shoulder 23 therebetween. Base portion 21 is circumscribed with a plurality of ribs 24 raised thereon in parallel, axially spaced apart relationship, which ribs serve to strengthen the wall, and which also have an additional purpose that will be subsequently referred to. Tubular spout 22 has a male thread 25 raised thereon.

The nozzle of assembly 10 includes at least one second part 30 which may suitably be in the form of a closed cap, as seen in FIG. 2, which cap has a female thread 31 formed therein to be connectable with male thread 25.

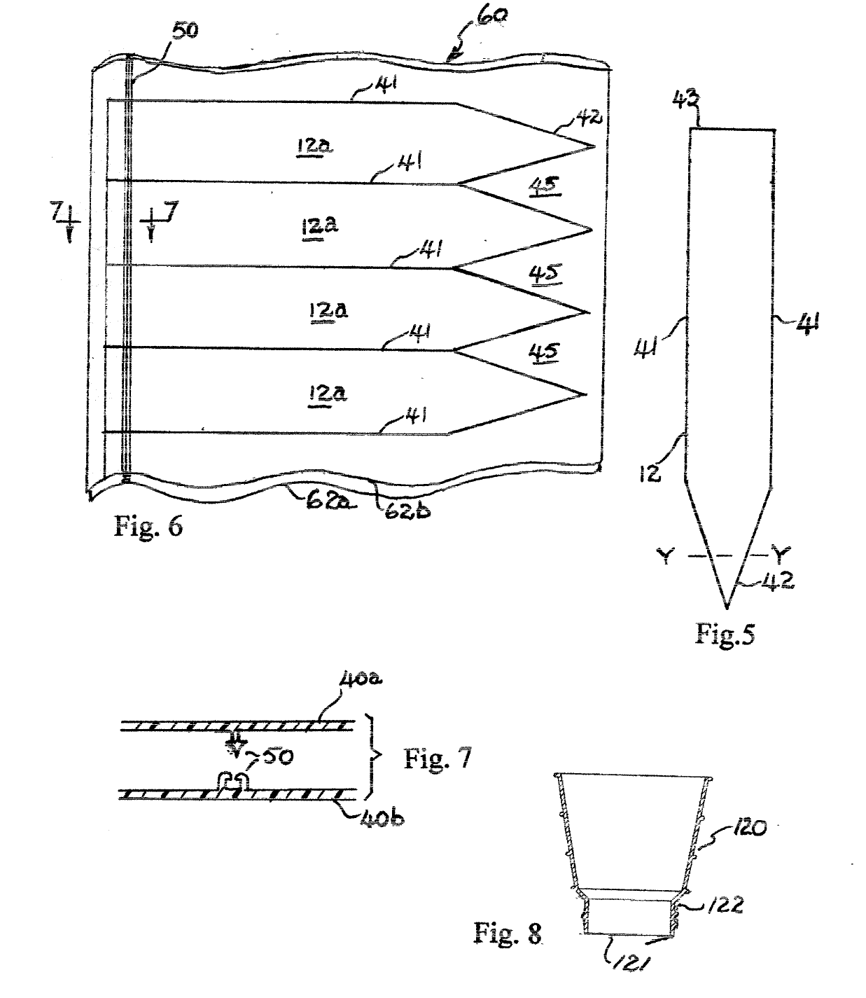

Pouch 12 in its unfilled condition, as best seen in FIGS. 5, 6 and 7 comprises a pair of flat film walls 40a, 40b, sealed together along laterally extending edges 41. Edges 41 are suitably parallel over the upper, major portion of pouch 12, and then converge to terminate in a nipple 42, in effect having an elongated pentagonal shape. The upper end 43 of pouch 12, in its flat, unfilled condition is open, to permit the first part 20 the nozzle means to be inserted into the pouch, and urged towards nipple 42, so causing the pouch to deform at least initially in an elastic manner in which it tightly grips and surrounds first nozzle part 20 in sealing relationship therewith. Suitably and preferably, the conical angle of the convergent wall portions of pouch 12 is generally the same as that of base portion 21, so as to enhance the gripping action of the walls of pouch 12 on first nozzle part 20. It will be appreciated that the film wall of pouch 12 will be in greatest tension where it passes over ribs 24, and that when first nozzle portion 20 is properly positioned in pouch 12, there will be little likelihood of leakage occurring between the pouch wall and nozzle part 20.

Following the sealing engagement of first nozzle part 20 with the wall of pouch 12, cap 30 will be coupled to the first nozzle part, thereby trapping portions of the pouch wall between the cap and the first nozzle part, following which pouch 12 may be filled with a filling medium M and hermetically closed along seal line 36. It should be emphasized here that cap 30 does not function at this stage to seal piping bag assembly 10 in any manner, and that the assembly could be distributed with the cap in an uncoupled state. However, it is preferred that the two nozzle parts be coupled together, as the second part serves to protect nipple 42 from mechanical damage. Still further, it serves to prevent the dislodgement of nozzle first part 20 from its sealing engagement with the wall of pouch 12 and its migration into the mass of filling medium M. Shrinking the pouch 12 onto the first nozzle part 20 may also serve to prevent the dislodgement of the nozzle first part. To this end, film walls 40a, 40b may be formulated to facilitate for example, thermal shrinkage, as is known in the art. Still other means of shrinkage may be used and may under some circumstances be preferred.

The user of filled, sealed assembly 10 is instructed to use the assembly by removing cap 30, and, following a visual inspection to determine that nipple 42 has not been tampered with, to sever the nipple marginally below shoulder 23. This will then permit filling medium M to be expressed from pouch 12 through the tubular outlet 22a of the first nozzle part 20. Should it be desired, assembly 10 might include one or more second nozzle parts, an exemplary alternative such part being seen in FIG. 4 and identified therein by the numeral 30′. It will be understood that nozzle second part 30′ may conveniently be coupled to first part 20 in an identical manner to that in which cap 30 is coupled, to permit piping of a different cross section to be extruded from assembly 10 through decorative tip 32. Irrespective of the precise nature of nozzle second part 30, it is desirable that when it is secured to the nozzle first part, it will trap a portion of the film wall of pouch 12 between the two nozzle parts, to reduce the possibility of the accidental dislodgement of the first nozzle part 20 as earlier spoken of. Conveniently, following the removal of nipple 42, this trapping action will arise between the upper peripheral end 33 of second nozzle part 30 and shoulder 23. When a user has partially used the filling medium M contained in piping bag assembly 10, closed cap 30 may be coupled with first nozzle part 20 to seal the contents of assembly 10 for storage and subsequent reuse if desired.

Assembly 10 as thus far described, is particularly suited for use in a commercial filling and sealing operation, although it is by no means limited thereto. Where assembly 10 is intended for sale to an end user in an unfilled condition, a modified pouch 12a, best seen in FIGS. 6 and 7 may be provided. Pouch 12a has a releasable closure means 50 at the upper end thereof. Conveniently, closure 50 comprises a zip fastener of a type commonly used in food storage bags, such as a push together or a slide fastener.

Pouches 12 and 12a are typically manufactured from a web 60 comprising to continuous, overlaying bands 62a, 62b of food grade plastic film by fusing the film together to form the side margins 41 of the pouches, with each pouch having a side margin in common with an adjacent pouch. The pouches 12 or 12a so formed may suitably remain in the web 60 to facilitate the packing and handling of the pouches at a filling station, and thereby reduce handling costs.

Where, as is particularly illustrated in FIG. 6, bands 62a, 62b include closure elements 50, these are suitably provided along one longitudinal side of the bands only, to reduce the cost of production of the bands. This leads to some material wastage, as the films portions 45 will be discarded. In practice such wastage is less than about five per cent of web 60. In comparison, were triangular shape pouches to be formed in web 60, the wastage would be approximately fifty per cent, and the cost of the closure elements 50 for a pouch of a given volume would be appreciably higher than it is for the elongated pentagonal pouch 12a.

While in the first embodiment of the invention the nipple end 42 of pouch 12 serves to enclose spout opening 22a and thereby form. a security seal for the contents M contained within piping bag 10, this arrangement may be changed if desired. Thus, as seen in FIG. 8, in a nozzle first part 120, a security seal 121 is provided at the outlet end of spout portion 122. Optionally, pouch 12 may be prepared at the time of its manufacture by severing nipple end 42 along the line Y-Y, which will permit the spout portion 122 of nozzle first part 120 to project through pouch 12 when assembled therewith.

1. A disposable piping bag comprising a thin, flexible pouch with an expressible, viscous medium sealed therein, said pouch collapsing on the expression of said medium therefrom; said pouch having a neck portion adjacent one axial end thereof having a conically reducing transverse cross-section;
nozzle means including a funnel-like nozzle base comprising conically inclined wall portions and a spout portion connected in flow relationship therewith;
said conically inclined wall portions having surface dislocations thereon;
said nozzle hose being disposed at least in part within said pouch with neck portions thereof in gripping relationship with said conically inclined wall portions so as to create a seal thereon, with said surface dislocations tending to resist reactive forces generated by said pouch to urge said nozzle base out of is gripped, sealed relationship;
said nozzle means further comprising a nozzle cup disposed outside of said pouch;
said nozzle base and said nozzle cap including complementary coupling means for selectively coupling said nozzle cap to said nozzle base with portions of said pouch trapped therebetween; and security seal means covering the outlet of said spout portion to prevent the expression of said medium from said pouch.

2. A disposable piping bag as set forth in claim 1 wherein said coupling means comprises thread means formed on said nozzle base and mating thread means formed on said nozzle cap.

3. A disposable piping bag as set forth in claim 1 wherein said security seal means is unitarily formed with said pouch.

4. A disposable piping bag as set forth in claim 1 wherein said nozzle cap is elongated and has a bore therethrough to form a nozzle tip.

5. A disposable piping bag as set forth in claim 1 wherein said pouch has a relatively constant radial cross section in upper portions thereof

6. A disposable piping bag as set forth in claim 1 wherein said pouch is shrink fitted onto said conical wall portions.

7. A disposable piping bag as set forth in claim 1 wherein said surface dislocations are in the form of a plurality of axially spaced apart ribs.

8. A disposable piping bag as set forth in claim 1 wherein said spout portion is connected to said conically inclined wall portions by a shoulder, and wherein said nozzle cap traps portions of said pouch against said shoulder.

9. A disposable piping bag as set forth in claim 1 wherein said security seal means is disposed at the outlet to said spout portion of said nozzle base.

10. A kit for forming a disposable piping bag comprising, in association, a pouch formed from a thin, flexible material expandable between a flat, generally two dimensional form when empty and a three dimensional form when filled, said pouch having axially opposed ends, one said end defining a fill opening for said pouch, the opposed end defining an outlet end;
said outlet end having a progressively diminishing width therealong;
a nozzle means comprising a base portion dimensioned to permit its insertion into said pouch through said fill opening and to be snugly received in said outlet end of said pouch in tightly gripped relation therewith, and a cap portion;
said base portion and said cap portion including complementary coupling means for selectively coupling together said portions with a portion of the film forming said pouch trapped therebetween, to thereby assist in retaining said first base portion when inserted into said pouch in its tightly gripped position;
said coupling means permitting the selective decoupling of said portions to permit a variety of different ones of said cap portion to couple to said first part.

11. A kit for forming a disposable piping bag as set forth in claim wherein said coupling means comprises thread means formed on said nozzle base and mating thread means formed on said nozzle cap.

12. A kit for forming a disposable piping bag as set forth in claim 10 wherein said nozzle base portion includes a truncated conical wall having surface dislocations thereon.

13. A kit for forming a disposable piping bag as set forth in claim 10 wherein said nozzle cap portion is tubular and is open at each end.

14. A kit for forming a disposable piping bag as set forth in claim 10 wherein said pouch has a relatively constant radial cross section in upper portions thereof

15. A kit for forming a disposable piping bag as set forth in claim 10 wherein said pouch is at least at said outlet end, constructed from a heat shrinkable thermo-plastic material.

16. A kit for forming a disposable piping bag as set forth in claim 10 wherein said base portion includes a truncated conical portion that is circumscribed with a plurality of axially spaced apart ribs.

17. A kit for forming a disposable piping bag as set forth in claim 16 wherein said base portion includes a spout portion which connects to said conical portion at a shoulder.

18. A kit for forming a disposable piping bag as set forth in claim 10 wherein said pouch includes matable sealing means adjacent said fill opening.

19. A kit for forming a disposable piping bag as set forth in claim 10 wherein said outlet end of said pouch terminates in a nipple.

20. A disposable piping bag as set forth in claim 10 wherein said outlet end of said pouch is open, and wherein said nozzle base portion is closed with an anti-tamper seal.

21. A kit for forming a disposible piping bag as defined in claim 10 wherein said pouch is pisposed in a web.

22. A nozzle means for a disposable piping bag comprising a funnel-shaped nozzle base including truncated conical funnel walls and a funnel spout connected to said funnel walls in flow relationship;
a nozzle cap;
coupling means for selectively coupling and decoupling said base and said cap;
said funnel walls being generally smooth, with surface dislocations thereon.

23. A nozzle means as defined in claim 22 wherein said coupling means comprises male thread portions disposed on said spout and complementary thread portions formed on said cap.

24. A nozzle means as defined in claim 22 wherein said cap is elongated and has a bore therethrough to form a nozzle tip.

25. A nozzle means as defined in claim 22 wherein said surface dislocations comprise a plurality of ribs which are raised on said funnel walls.

26. A nozzle means as defined in claim 22 wherein said nozzle base at least is manufactured from stainless steel.
